(19) United States
(12) Patent Application Publication
(10) Pub. No.: US 2024/0147297 A1
(43) Pub. Date: May 2, 2024

(54) METHODS FOR RESILIENT MULTI CLOUD GATEWAY INTERCONNECTS

(71) Applicant: VMware, Inc., Palo Alto, CA (US)

(72) Inventors: Navaneeth Krishnan Ramaswamy, Chennai (IN); Santosh Pallagatti Kotrabasappa, Bangalore (IN)

(21) Appl. No.: 17/976,717

(22) Filed: Oct. 28, 2022

(51) Int. Cl. H04W 28/02

(52) U.S. Cl. CPC H04W 28/0268; H04W 28/021; H04W 28/0242

(57) ABSTRACT

Some embodiments of the invention provide a method for enabling inter-gateway connectivity in an SD-WAN (software-defined wide area network) that connects multiple sites. The method deploys to the SD-WAN a floating hub gateway router that that (1) connects to multiple gateway routers each of which is deployed in a cloud and connects to at least one edge router in at least one site, and (2) does not connect to edge routers at any site. The method provides a network address associated with the floating hub gateway router to the multiple gateway routers deployed in one or more clouds for the SD-WAN. The method configures the floating hub gateway router to establish a tunnel with each gateway router in the multiple gateway routers to enable inter-gateway connectivity between the multiple gateway routers.

### BACKGROUND

Today, a typical SD-WAN (software-defined wide area network) deployment includes cloud gateway routers deployed to clouds (e.g., cloud PoPs (points of presence)) to facilitate waypoints for internet traffic toward cloud destinations. Thousands of such cloud gateway routers are deployed across the globe, which are assigned to various edge routers located at remote branch sites belonging to tenants of the SD-WAN, with each edge router being allocated a subset of cloud gateways assigned based on location proximity. However, interconnections between cloud gateways across regions are limited or non-existent, as the cloud gateways are independent of each other and do not communicate with each other. As such, these cloud gateway routers do not have any way to reach one another and are isolated as a result. Current solutions provide gateway interconnect by treating them as external VPN (virtual private network) services with generic IPsec (Internet protocol security) policies to establish IPsec tunnels, which further requires BGP (border gateway protocol) services on both ends such that SD-WAN overlay routes be advertised across the IPsec tunnel.

### BRIEF SUMMARY

Some embodiments of the invention provide a method for enabling inter-gateway connectivity in an SD-WAN (software-defined wide area network) that connects multiple sites. The method is performed, in some embodiments, by an SD-WAN controller (e.g., VeloCloud's VCO (VeloCloud orchestrator)). The method deploys to the SD-WAN (e.g., to a cloud in the SD-WAN) a floating hub gateway router that (1) connects to gateway routers each of which is deployed in a cloud and connects to at least one edge router in at least one site, and (2) does not connect to edge routers at any site. The method provides a network address (i.e., IP (Internet protocol) address) associated with the floating hub gateway to the multiple gateway routers deployed in one or more clouds for the SD-WAN, and configures the floating hub gateway router to establish a tunnel with each of the gateway routers to enable inter-gateway connectivity between the multiple gateway routers.

In some embodiments, the floating hub gateway router is configured to establish secure tunnels with each gateway router using several physical network links between the floating hub gateway and the gateway router. The floating hub gateway router, in some embodiments, is further configured to perform a multi-link optimization process to establish each secure tunnel between the floating hub gateway router and each gateway router for use in sending data traffic between the floating hub gateway router and each gateway router. In some embodiments, the set of physical network links includes at least one commercial Internet link that enables the connection from the floating hub gateway router in the cloud to each of the gateway routers. The commercial Internet network link is provided by an Internet service provider (ISP), according to some embodiments.

Upon establishing the secure tunnels with each of the gateway routers, in some embodiments, the floating hub gateway router enables a full mesh between the gateway routers. In some embodiments, the gateway routers are grouped into a set of gateway pools, with each gateway router belonging to a respective gateway pool in the set of gateway pools. Gateway routers belonging to different gateway pools are not able to communicate without the floating hub gateway router, and as such, the deployment of the floating hub gateway enables end-to-end communications between the gateway routers that would otherwise be unable to communicate.

The SD-WAN is a multi-tenant SD-WAN that serves multiple tenants, according to some embodiments. In some such embodiments, the gateway routers deployed in one or more clouds for the SD-WAN to which the floating hub gateway router connects are multi-tenant gateway routers that provide services for the multiple tenants served by the SD-WAN. In some embodiments, each gateway pool in the set of gateway pools is associated with at least one tenant serviced by the multi-tenant SD-WAN.

In some embodiments, after providing the network address associated with the floating hub gateway router to the gateway routers, each gateway router provides a set of routes associated with the gateway router to the floating hub gateway router, which the floating hub gateway router, in turn, provides to each other gateway router. The SD-WAN controller, in some embodiments, dynamically adds new gateway routers to the floating hub gateway router (e.g., when new gateway routers are deployed to the SD-WAN or when profiles of existing gateway routers are updated), which then establishes secure tunnels with the new gateway routers. Based on the full mesh established by the floating hub gateway router, the floating hub gateway router of some embodiments acts as a route reflector for route distribution.

The floating hub gateway router, in some embodiments, is deployed to the SD-WAN with an isolation profile. In some embodiments, the isolation profile identifies a first subset of gateway routers that are not permitted to communicate with a second subset of gateway routers. The first and second subsets of gateway routers include first and second subsets of gateway pools, in some embodiments, to which first and second tenants of the SD-WAN are respectively assigned. In some such embodiments, the isolation profile prevents communications between the first and second subsets of gateway pools, and thereby also prevents communications between the first and second tenants, according to some embodiments.

In some embodiments, the isolation profile identifies a third subset of gateway routers that are associated with a set of clouds connected by the SD-WAN. Each cloud in the set of clouds, in some embodiments, hosts one or more applications for providing one or more services to tenants of the SD-WAN. In some such embodiments, the isolation profile can specify that each of the first and second subsets of gateway routers are allowed to communicate with the third subset of gateway routers in order to access the one or more services provided by the one or more applications hosted by the set of clouds. As a result, the first and second subsets of gateway pools (and the tenants assigned to these gateway pools) are isolated from one another, while a full mesh is still enabled between gateway routers deployed in the SD-WAN.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates a diagram of an SD-WAN network of some embodiments in which a floating hub gateway is deployed to provide inter-gateway connectivity for gateways deployed in the SD-WAN.

FIG. 2 conceptually illustrates a process performed by an SD-WAN controller in some embodiments to enable inter-gateway connectivity for an SD-WAN.

FIG. 3 conceptually illustrates communications between an SD-WAN controller and SD-WAN forwarding elements of some embodiments, including a floating hub gateway, deployed in an SD-WAN.

FIG. 4 conceptually illustrates a process performed in some embodiments by a floating hub gateway that has been deployed to the cloud.

FIG. 5 conceptually illustrates an SD-WAN of some embodiments after a controller has deployed a floating hub gateway, provided a gateway accept list configuration to the deployed floating hub gateway, and configured an IP address assigned to the floating hub gateway in each gateway pool.

FIG. 6 conceptually illustrates a process performed in some embodiments by a gateway router deployed in an SD-WAN to route data traffic from an edge router at a branch network to a destination gateway (e.g., for a public or private cloud) to which there is no direct route.

FIG. 7 conceptually illustrates an SD-WAN of some embodiments in which end-to-end multipath optimization is utilized.

FIG. 8 conceptually illustrates an SD-WAN of some embodiments in which data traffic is forwarded from a first destination gateway back through a floating hub gateway to a second destination gateway.

FIGS. 9-10 conceptually illustrate two examples of gateway segmentation for SD-WANs of some embodiments in which floating hub gateways are deployed.

FIG. 11 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method for enabling inter-gateway connectivity in an SD-WAN (software-defined wide area network) that connects multiple sites. The method is performed, in some embodiments, by an SD-WAN controller (e.g., VeloCloud's VCO (VeloCloud orchestrator)). The method deploys to the SD-WAN (e.g., to a cloud in the SD-WAN) a floating hub gateway router that (1) connects to gateway routers each of which is deployed in a cloud and connects to at least one edge router in at least one site, and (2) does not connect to edge routers at any site. The method provides a network address (i.e., IP (Internet protocol) address) associated with the floating hub gateway to the multiple gateway routers deployed in one or more clouds for the SD-WAN, and configures the floating hub gateway router to establish a tunnel with each of the gateway routers to enable inter-gateway connectivity between the multiple gateway routers.

In some embodiments, the floating hub gateway router is configured to establish secure tunnels with each gateway router using several physical network links between the floating hub gateway and the gateway router. The floating hub gateway router, in some embodiments, is further configured to perform a multi-link optimization process to establish each secure tunnel between the floating hub gateway router and each gateway router for use in sending data traffic between the floating hub gateway router and each gateway router. In some embodiments, the set of physical network links includes at least one commercial Internet link that enables the connection from the floating hub gateway router in the cloud to each of the gateway routers. The commercial Internet network link is provided by an Internet service provider (ISP), according to some embodiments.

Upon establishing the secure tunnels with each of the gateway routers, in some embodiments, the floating hub gateway router enables a full mesh between the gateway routers. In some embodiments, the gateway routers are grouped into a set of gateway pools, with each gateway router belonging to a respective gateway pool in the set of gateway pools. Gateway routers belonging to different gateway pools are not able to communicate without the floating hub gateway router, and as such, the deployment of the floating hub gateway enables end-to-end communications between the gateway routers that would otherwise be unable to communicate.

The SD-WAN is a multi-tenant SD-WAN that serves multiple tenants, according to some embodiments. In some such embodiments, the gateway routers deployed in one or more clouds for the SD-WAN to which the floating hub gateway router connects are multi-tenant gateway routers that provide services for the multiple tenants served by the SD-WAN. In some embodiments, each gateway pool in the set of gateway pools is associated with at least one tenant serviced by the multi-tenant SD-WAN.

In some embodiments, after providing the network address associated with the floating hub gateway router to the gateway routers, each gateway router provides a set of routes associated with the gateway router to the floating hub gateway router, which the floating hub gateway router, in turn, provides to each other gateway router. The SD-WAN controller, in some embodiments, dynamically adds new gateway routers to the floating hub gateway router (e.g., when new gateway routers are deployed to the SD-WAN or when profiles of existing gateway routers are updated), which then establishes secure tunnels with the new gateway routers. Based on the full mesh established by the floating hub gateway router, the floating hub gateway router of some embodiments acts as a route reflector for route distribution.

The floating hub gateway router, in some embodiments, is deployed to the SD-WAN with an isolation profile. In some embodiments, the isolation profile identifies a first subset of gateway routers that are not permitted to communicate with a second subset of gateway routers. The first and second subsets of gateway routers include first and second subsets of gateway pools, in some embodiments, to which first and second tenants of the SD-WAN are respectively assigned. In some such embodiments, the isolation profile prevents communications between the first and second subsets of gateway pools, and thereby also prevents communications between the first and second tenants, according to some embodiments.

In some embodiments, the isolation profile identifies a third subset of gateway routers that are associated with a set of clouds connected by the SD-WAN. Each cloud in the set of clouds, in some embodiments, hosts one or more applications for providing one or more services to tenants of the SD-WAN. In some such embodiments, the isolation profile can specify that each of the first and second subsets of gateway routers are allowed to communicate with the third subset of gateway routers in order to access the one or more services provided by the one or more applications hosted by the set of clouds. As a result, the first and second subsets of gateway pools (and the tenants assigned to these gateway pools) are isolated from one another, while a full mesh is still enabled between gateway routers deployed in the SD-WAN.

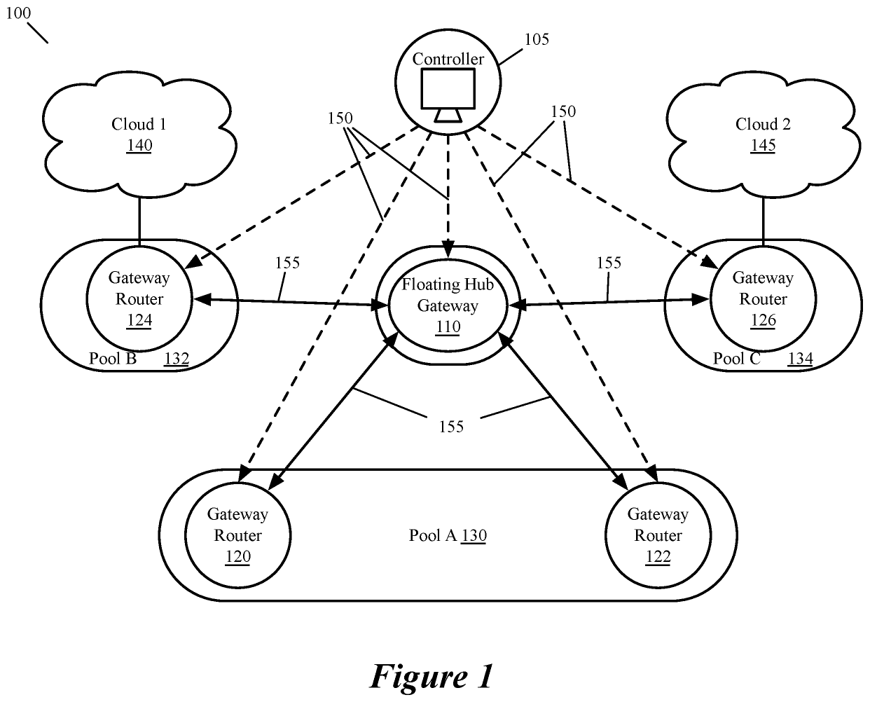

FIG. 1 illustrates a diagram of an SD-WAN network 100 of some embodiments in which a floating hub gateway is deployed to provide inter-gateway connectivity for gateways deployed in the SD-WAN. The SD-WAN 100 includes an SD-WAN controller 105, floating hub gateway 110, a first cloud 140, a second cloud 145, and multiple gateway routers 120, 122, 124, and 126. The multiple gateway routers 120-126 belong to different gateway pools 130, 132, and 134. More specifically, gateway routers 120 and 122 belong to pool A 130, while gateway router 124 belongs to pool B 132, and gateway router 126 belongs to pool C 134.

In some embodiments, each gateway router 120-126 is placed in a gateway pool upon deployment, and each customer (i.e., SD-WAN tenant) is assigned to a particular gateway pool. Once a customer has been assigned to a gateway pool, the SD-WAN edge routers and SD-WAN hub routers of that customer (e.g., edge routers deployed to branch sites belonging to the customer) will only be able to connect to the gateway routers belonging to the gateway pool assigned to the customer, according to some embodiments. Each gateway router, in some embodiments, performs forwarding and routing operations for the SD-WAN to route data traffic between different SD-WAN edge routers and SD-WAN hubs connected to the gateway router. In addition to the forwarding and routing operations, the gateway routers deployed in the SD-WAN also act as controllers by distributing SD-WAN hub and SD-WAN edge router information to all SD-WAN hubs and SD-WAN edge routers connected to the gateway routers. As a result, in some embodiments, edge routers deployed at different branch sites that are assigned to different gateway pools, and thus connect to different gateways in different gateways pools, do not have any means to communicate with each other.

The floating hub gateway 110 is a floating hub gateway router that provides inter-gateway connectivity between all of the gateway routers 120-126, as indicated by the connections 155 between the floating hub gateway 110 and each gateway router 120-126, in order to enable full mesh connectivity for all of the gateway routers based on configuration pushed from the controller 105 (e.g., via the connections 150 between the controller 105 and each of the gateway routers 120-126 and the floating hub gateway 110). SD-WAN hubs, in some embodiments, are hub forwarding elements (e.g., routers) that are used to connect to edge forwarding elements (e.g., edge routers) located at various branch sites (not shown) connected by the SD-WAN to each other, as well as to resources at datacenters that, in some embodiments, host the SD-WAN hubs.

In some embodiments, SD-WAN hubs use or have one or more service engines to perform services (e.g., middlebox services) on data traffic that it forwards from one branch site to another branch site. However, unlike the traditional SD-WAN hubs, the floating hub gateway router in the embodiments described herein is a multitenant router that connects gateway routers to other gateway routers, and does not connect edge routers at branch sites (i.e., single tenant/per-enterprise entity routers) to other edge routers at other branch sites.

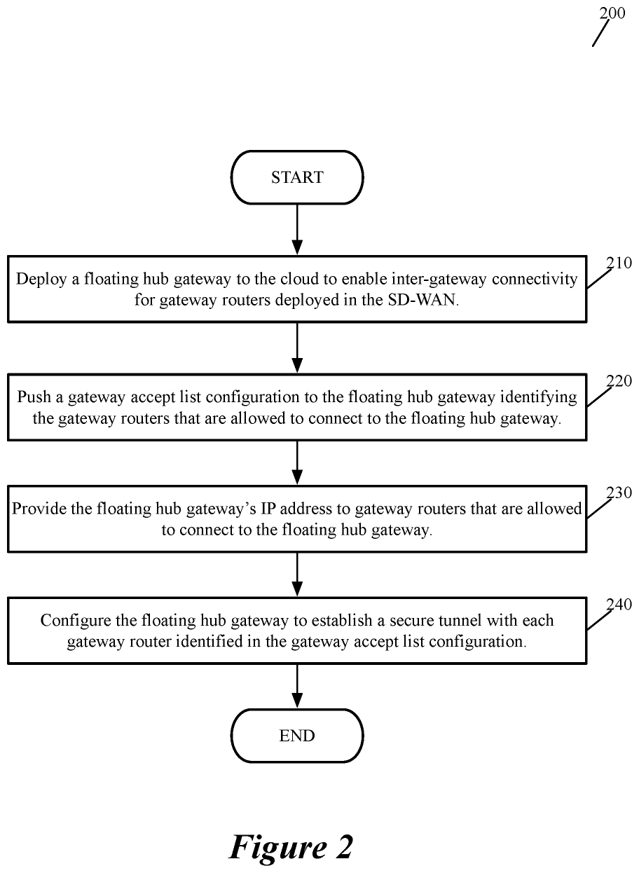

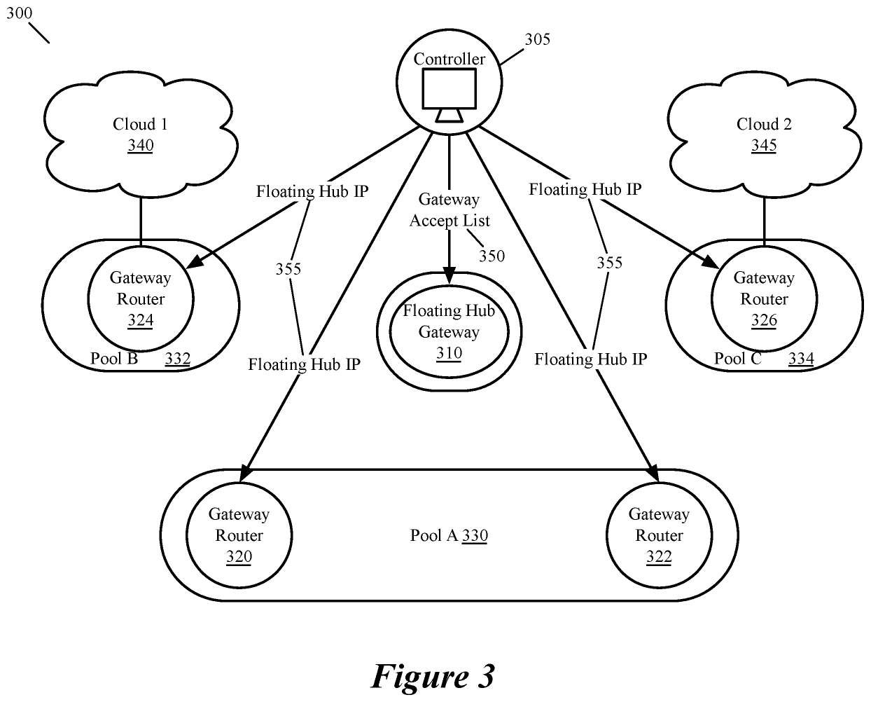

FIG. 2 conceptually illustrates a process 200 performed by an SD-WAN controller in some embodiments to enable inter-gateway connectivity for an SD-WAN. The process 200 will be described below with references to the SD-WAN 100 illustrated by FIG. 1, as well as to FIG. 3, which conceptually illustrates communications between an SD-WAN controller and SD-WAN forwarding elements of some embodiments, including a floating hub gateway, deployed in an SD-WAN. The process 200 starts when the SD-WAN controller deploys (at 210) a floating hub gateway to the cloud to enable inter-gateway connectivity. For example, the floating hub gateway 110 is deployed in the SD-WAN 100 by the SD-WAN controller 105 to provide inter-gateway connectivity between the gateway routers 120-126. As a result of the deployment of the floating hub gateway 110, a full mesh among the gateway routers 120-126 is enabled in the SD-WAN 100.

The full mesh enabled by the floating hub gateway router 110, in some embodiments, also enables branch sites assigned to different gateway pools to communicate. That is, as mentioned above, customer edge routers and hubs can only connect to gateways in the gateway pool assigned to that customer, and thus branch sites connected to different gateways of different gateway pools do not have any means to communicate with each other without the addition of the floating hub gateway router 110 and the full mesh among the gateway routers enabled by its deployment, according to some embodiments.

The process 200 pushes (at 220) a gateway accept list configuration to the floating hub gateway identifying the gateway routers that are allowed to connect to the floating hub gateway. The gateway accept list configuration, in some embodiments, includes a list of gateway routers with which the floating hub gateway is allowed to establish connections. In some embodiments, the gateway accept list is a filtered list generated after all isolations that are required based on policy and/or settings to facilitate per-gateway level filtering have been applied (i.e., no gateway router interconnect required specifications). The controller (e.g., SD-WAN controller) then generates this accept-list and pushes it to the floating hub gateway, and the floating hub gateway then iterates over the accept-list and establishes tunnels towards specified gateway routers, according to some embodiments.

The SD-WAN 300 illustrated in FIG. 3 includes an SD-WAN controller 305, a floating hub gateway 310, clouds 340 and 345, and multiple gateway routers 320, 322, 324, and 326 grouped into various pools 330, 332, and 334. In this example, the floating hub gateway 310 has just been deployed and activated, and thus no connections between the floating hub gateway 310 and any of the gateway routers 320-326 have been established. Instead, the SD-WAN controller 305 pushes a gateway accept list 350 to the floating hub gateway 310 to provide the floating hub gateway 310 with the gateway routers to be included in the full mesh enabled by the floating hub gateways.

In some embodiments, the gateway accept list configuration provided to the floating hub gateway includes each gateway router deployed in the SD-WAN. In other embodiments, the gateway accept list configuration includes only a portion of gateway routers deployed in the SD-WAN. Also, in some embodiments, the controller is configured to dynamically add gateway routers to the floating hub gateway after the initial gateway accept list configuration has been provided, such as when new gateway routers are deployed in the SD-WAN.

The process 200 provides (at 230) the floating hub gateway's IP address to gateways that are allowed to connect to the floating hub gateway. In some embodiments, steps 230 and 220 are performed simultaneously such that as the controller provides the gateway accept list configuration to the floating hub gateway, the controller also provides the IP address assigned to the floating hub gateway to the gateway routers with which the floating hub gateway will eventually connect. In the SD-WAN 300, for example, the controller 305 is also shown pushing the floating hub gateway IP address 355 to each gateway router 320-326. The controller 305, in some embodiments, configures the floating hub gateway's IP address 355 in each gateway pool 330-334 such that the floating hub gateway 310 is specified as a next hop in next hop forwarding rules for certain communications.

The process 200 configures (at 240) the floating hub gateway to establish a secure tunnel with each gateway identified in the gateway accept list configuration. In some embodiments, when the controller provisions the floating hub gateway, the controller also configures the floating hub gateway to establish connections with gateway routers in the SD-WAN based on the gateway accept list configuration provided to the floating hub gateway after deployment and activation. In some such embodiments, the controller instructs the floating hub gateway to establish the connections after providing the gateway accept list configuration, while in other embodiments, the floating hub gateway is configured to automatically establish the connections upon receipt of the gateway accept list configuration and detection of WAN links to each gateway router.

In some embodiments, the established connections are secure multipath tunnels established on top of multiple physical network links. The multiple physical network links, in some embodiments, include at least a commercial Internet link (e.g., provided by an ISP), which allows connections to forwarding elements deployed to clouds. An example of a secure multipath tunnel, in some embodiments, includes a VCMP (VeloCloud multipath) tunnel, which is an overlay tunnel in which traffic receives the benefit of optimized WAN (wide area network) links, such as through DMPO (dynamic multi-path optimization). As a result, all of the SD-WAN forwarding elements (i.e., gateway forwarding elements, edge forwarding elements, and hub forwarding elements) will be able to receive routes from other gateway routers, thereby enabling end-to-end communication between branch sites having no common gateway. The floating hub gateway will act as a route reflector for route distribution and will also enable gateway router-to-gateway router traffic communication. Additional details regarding WAN optimization, and DMPO, will be further described in relation to the embodiments below. Following 240, the process 200 ends.

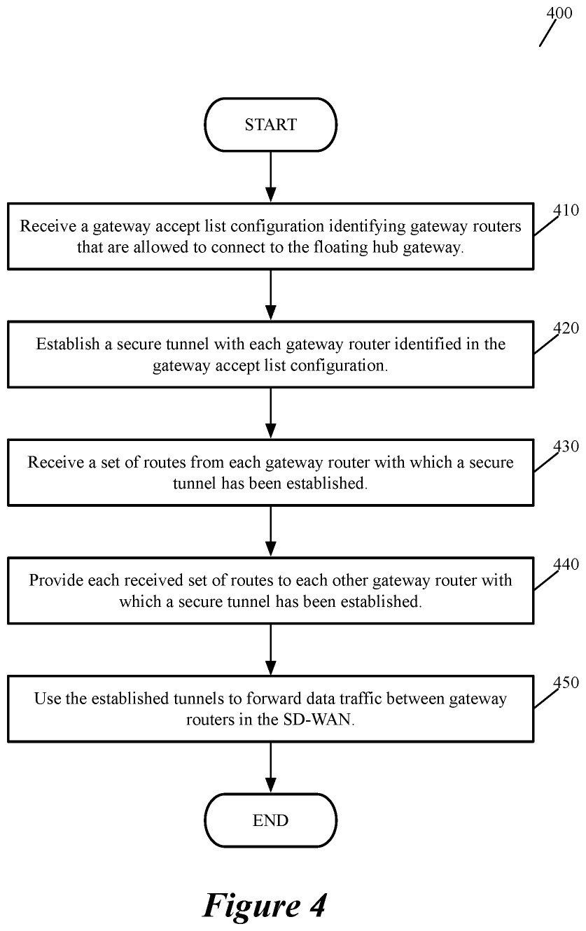

FIG. 4 conceptually illustrates a process 400 performed by a floating hub gateway that has been deployed to the cloud. The process 400 starts when the floating hub gateway receives (at 410) a gateway accept list configuration identifying gateways that are allowed to connect to the floating hub gateway. The floating hub gateway 310 in the SD-WAN 300 described above, for instance, receives a gateway accept list configuration 350 from the SD-WAN controller 305. The gateway accept list can include all, or some, of the gateway routers deployed in the SD-WAN, according to some embodiments.

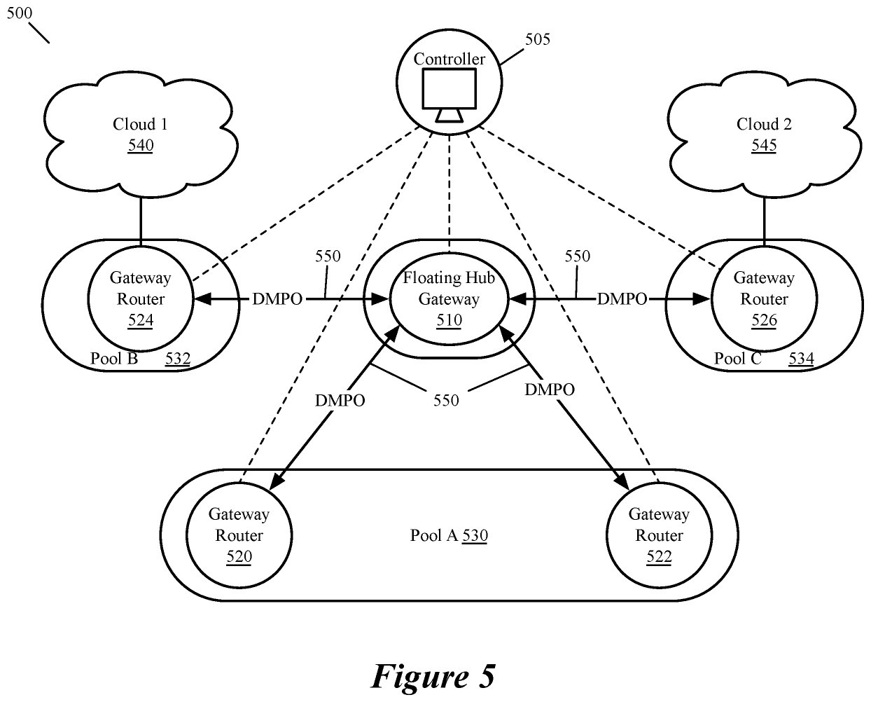

The process 400 establishes (at 420) a secure tunnel with each gateway identified in the gateway accept list configuration. FIG. 5 conceptually illustrates an SD-WAN 500 of some embodiments after a controller 505 has deployed a floating hub gateway 510, provided a gateway accept list configuration to the deployed floating hub gateway 510, and configured an IP address assigned to the floating hub gateway in each gateway pool 530, 532, and 534. As shown, the floating hub gateway 510 has established secure tunnels 550 with each gateway router 520, 522, 524, and 526. The tunnels 550 enable a full mesh among the gateway routers 520-526, thereby also enabling inter-gateway connectivity for the gateway routers 520-526 by way of the floating hub gateway 510.

In some embodiments, the floating hub gateway 510 establishes the secure tunnels 550 after receiving instructions to do so from the controller 505, while in other embodiments, the floating hub gateway 510 is configured to begin establishing the secure tunnels 550 once it has received the gateway accept list configuration from the controller 505 and detected a WAN link between the floating hub gateway 510 and a gateway router 520-526. The floating hub gateway 510 and each gateway router 520-526 are configured to utilize SD-WAN services to optimize data traffic sent between SD-WAN forwarding devices (i.e., the floating hub gateway and the gateway routers) in the SD-WAN, according to some embodiments. For example, in some embodiments, the floating hub gateway 510 and each gateway router 520-526 utilize services such as DMPO.

When the floating hub gateway 510 and each gateway router 520-526 utilize DMPO, the floating hub gateway 510 and each gateway router 520-526 run bandwidth tests using short bursts of bi-directional traffic through the secure tunnels 550. In some embodiments, the floating hub gateway 510 and/or each gateway router 520-526 can identify real public IP addresses of WAN links in cases where, e.g., the WAN link is a private link, according to some embodiments. Also, in some embodiments, once the secure tunnels 550 are established, DMPO performs uni-directional performance metric measurements for metrics such as loss, latency, and jitter, for every data message on every DMPO tunnel between two DMPO endpoints (i.e., the floating hub gateway 510 and each gateway router 520-526).

In some embodiments, the DMPO tunnel header used to encapsulate each packet sent through the secure tunnel 550 includes performance metrics such as sequence number and timestamp to enable the DMPO endpoints to identify lost packets and out-of-order packets, as well as to compute jitter and latency bi-directionally. These performance metrics are communicated between the DMPO endpoints at an order of every 100 ms, according to some embodiments, and when there is no active data traffic being sent through the DMPO tunnels, the DMPO endpoints instead send active probes every 100 ms, or every 500 ms after a certain period (e.g., 5 minutes) of no high-priority data traffic. Additionally, for any private WAN links for which a class of service (CoS) agreement is defined, DPMO is configured in some embodiments to take the CoS agreement into account both for all traffic steering decisions (e.g., monitoring traffic, data plane application traffic, etc.). DMPO can also add Forward Error Correction (FEC) for certain classes of traffic, according to some embodiments.

The process 400 receives (at 430) a set of routes from each gateway with which a secure tunnel has been established. For instance, in the SD-WAN 500, the floating hub gateway 510 receives route sets from each of the gateway routers 520-526 via the tunnels 550. The routes are pushed to the floating hub gateway 510, in some embodiments, using a particular protocol (e.g., VCRP (VeloCloud routing protocol) according to configurations from the controller 505.

In some embodiments, profile-based VPN (virtual private network) settings are enabled on the floating hub gateway 510 to ensure the floating hub gateway 510 will have full mesh optimized connectivity with the gateway routers 520-526, and still have isolation within full mesh. That is, in some embodiments, profile-based VPN settings are leveraged to allow interconnections between only a subset of gateways. In some embodiments, for example, gateway pools are segmented to allow certain gateway routers from certain gateway pools to communicate, while preventing other gateway routers from other gateway pools from communicating with gateway routers outside of those other gateway pools. Isolation and segmentation will be further described in embodiments below.

The process 400 provides (at 440) each received set of routes to each other gateway with which a secure tunnel has been established. Once the floating hub gateway 510 has received the route sets from each gateway router 520-526, the floating hub gateway 510 forwards each route set to each other gateway router 520-526 connected to the floating hub gateway 510. In some embodiments, the floating hub gateway 510 also forwards the routes to any other gateway routers (not shown) in the SD-WAN 500 to which the floating hub gateway 510 will subsequently establish secure tunnels. After receiving these route sets from the floating hub gateway 510, each gateway router 520-526 shares the route sets with other hub routers and edge routers connected to the gateway router based on profile configurations of those forwarding elements.

The process 400 uses (at 450) the established tunnels to forward data traffic between gateways in the SD-WAN. For instance, the floating hub gateway 510 forwards data traffic between each of the gateway routers 520-526 in the SD-WAN 500 using the secure tunnels 550, such as from any of the gateway routers 520-522 to the gateway routers 524-526 for data traffic destined to either of the clouds 540-545. As mentioned above, the controller 505 can dynamically add gateway routers to the floating hub gateway, according to some embodiments, such as when new gateway routers are added to the SD-WAN, or to add an existing gateway router following a profile change. Following 450, the process 400 ends.

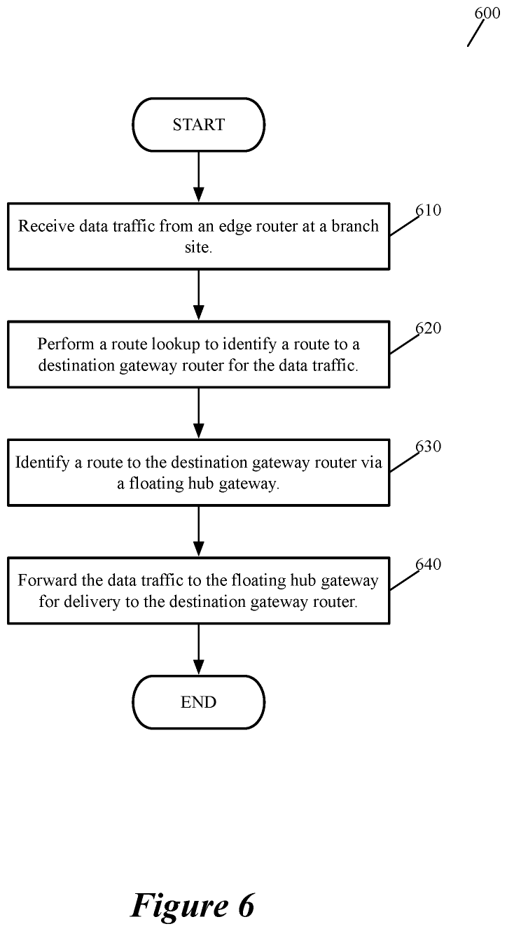

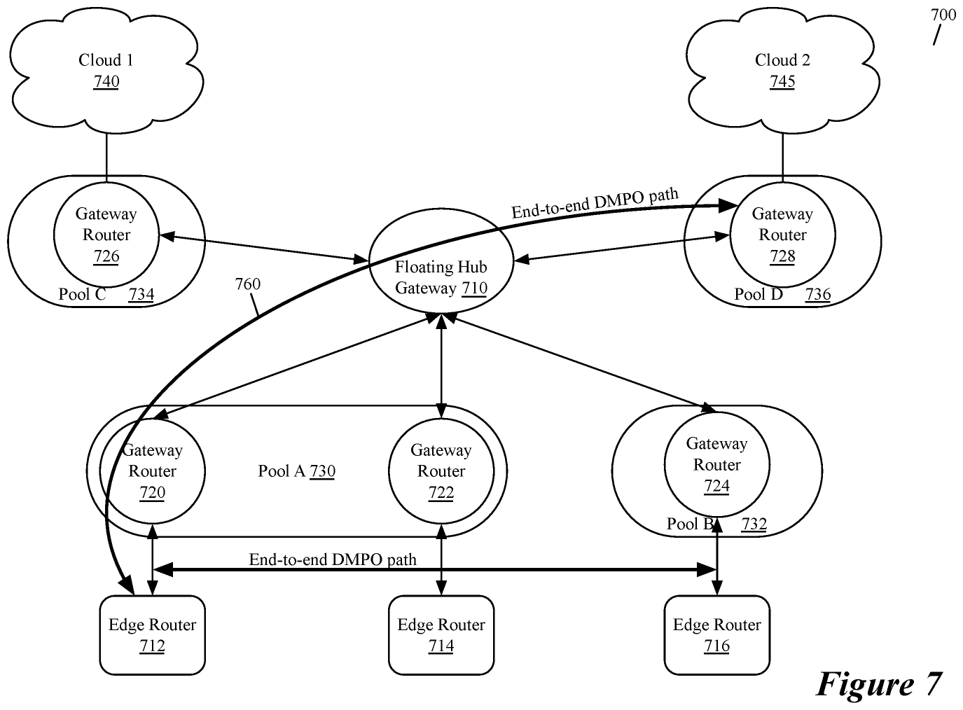

FIG. 6 conceptually illustrates a process 600 performed in some embodiments by a gateway router deployed in an SD-WAN to route data traffic from an edge router at a branch network to a destination gateway (e.g., for a public or private cloud) to which there is no direct route. The process 600 will be described below with references to FIG. 7, which conceptually illustrates an SD-WAN 700 of some embodiments in which end-to-end multipath optimization is utilized. The SD-WAN 700 includes a floating hub gateway 710, edge routers 712-716 located at branch sites (not shown) connected by the SD-WAN 700, clouds 740 and 745, and gateway routers 720, 722, 724, 726, and 728.

In this example, gateway routers 720 and 722 belong to gateway pool A 730, gateway router 724 belongs to gateway pool B 732, gateway router 726 belongs to gateway pool C 734, and gateway router 728 belongs to gateway pool D 736. Additionally, as shown, gateway router 720 is a default gateway router assigned to edge router 712, gateway router 722 is a default gateway router assigned to edge router 714, and gateway router 724 is a default gateway router assigned to edge router 716. Because gateway routers 720 and 722 belong to the same gateway pool A 730, edge routers 712 and 714 can communicate via their respective gateway routers 720-722 without requiring the floating hub gateway 710, while each other gateway router 724-728 does require the floating hub gateway 710 for any inter-gateway connectivity.

The process 600 starts when the gateway router receives (at 610) data traffic from an edge router at a branch site. For instance, in the SD-WAN 700, the gateway router 720 receives data traffic from the edge router 712. Because the gateway routers 720 and 722 belong to the same gateway pool A 730, data traffic sent from the edge router 712 to the gateway router 720 can be forwarded to either the gateway router 722 or the floating hub gateway 710 based on the destination of the data traffic. Additionally, because the edge routers 712 and 714 have default gateway routers belonging to the same pool 730, it should be noted that a direct route between edge routers 712 and 714 can be established when allowed within their profiles, according to some embodiments.

Like the communications described in the embodiments above, the data traffic sent between edge routers and gateway routers are also sent through secure tunnels that utilize optimization services made available by the SD-WAN (e.g., DMPO). After each edge router 712-716 is assigned (e.g., by a controller (not shown) for the SD-WAN 700) a default gateway router 720-724, and detects a WAN link, the edge router 712-716 establishes a secure tunnel with its assigned default gateway router 720-724, in some embodiments. As such, each connection between each forwarding element in the SD-WAN 700 is a secure tunnel through which traffic is optimized, thereby establishing end-to-end optimization.

The process 600 performs (at 620) a route lookup to identify a route to a destination gateway for the data traffic. Each gateway router, in some embodiments, has a set of forwarding rules that identify next hops for reaching various destinations in and out of the SD-WAN, and upon receiving data traffic from an edge router, the gateway router identifies a forwarding rule based on information from the received data traffic. The routes specified by the forwarding rules include direct routes to the specified destinations as well as routes through the floating hub gateway. For example, a direct route from the edge router 712 to the edge router 714 would include the gateway router 722 as a next hop from the gateway router 720, whereas any routes to reach the clouds 740 and 745 from any of the edge routers 712-716 would require the data traffic to be sent via the floating hub gateway 710.

The process 600 identifies (at 630) a route to the destination gateway via a floating hub gateway deployed to a cloud to provide inter-gateway connectivity for the SD-WAN. The route 760 that extends from the edge router 712 to the gateway router 728 is one example of a route to a destination gateway that traverses the floating hub gateway 710. Without the floating hub gateway 710, the gateway router 720 would not be able to reach the gateway router 728 within the SD-WAN 700, and thus would not be able to send the data traffic with the benefits of any optimizations available through the SD-WAN.

The process 600 forwards (at 640) the data traffic to the floating hub gateway for delivery to the destination gateway. The gateway router 720 uses the route 760 to forward data traffic to the floating hub gateway 710 in order to reach the destination gateway router 728 in the SD-WAN 700. Each forwarding element (i.e., edge router, gateway router, floating hub gateway) utilizes optimization services available through the SD-WAN 700, according to some embodiments. As indicated, the path 760 is an end-to-end DMPO (i.e., optimized) path. Following 640, the process 600 ends.

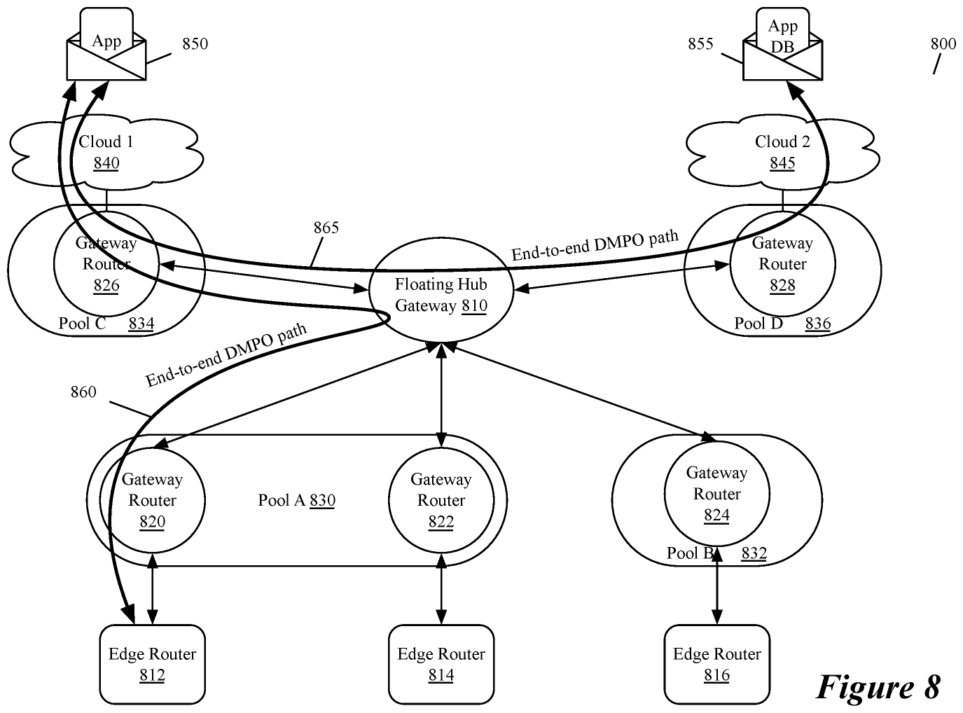

In some embodiments, a destination application for the data traffic can refer to a database that is located in another cloud (i.e., other than the cloud hosting the destination application). FIG. 8 conceptually illustrates an SD-WAN 800 of some embodiments in which data traffic is forwarded from a first destination gateway back through a floating hub gateway to a second destination gateway. As shown, the SD-WAN 800 includes a floating hub gateway 810, edge routers 812-816, clouds 840 and 845, and gateway routers 820-828.

In this example, gateway routers 820 and 822 belong to gateway pool A 830, gateway router 824 belongs to gateway pool B 832, gateway router 826 belongs to gateway pool C 834, and gateway router 828 belongs to gateway pool D 836. Gateway router 820 is the default gateway for edge router 812, gateway router 822 is the default gateway for edge router 814, and gateway router 824 is the default gateway for edge router 816. Additionally, gateway router 826 provides access to cloud 840 that hosts an application 850, while gateway router 828 provides access to cloud 845 that hosts a database 855 for the application 850.

When the gateway router 820 receives data traffic from the edge router 812, the gateway router 820 performs a lookup to identify a route to a destination of the data traffic (i.e., the cloud application 850 hosted by cloud 840) specified by a forwarding rule defined for the gateway router 820. The gateway router 820 then forwards the data traffic to the next hop, the floating hub gateway 810, along the path 860. The floating hub gateway 810 then forwards the data traffic to the gateway router 826 for the cloud 840 along the path 860 for delivery to the cloud application 850.

In some embodiments, when the cloud application 850 refers to the database 855, which is located in a different cloud 845, the destination gateway router 826 performs a route lookup to identify a route to the other cloud 845. As illustrated, the identified route 865 indicates the floating hub gateway 810 as the next hop, and as such, the destination gateway router 826 forwards the data traffic back to the floating hub gateway 810 over a secure optimized tunnel along the path 865, and the floating hub gateway 810 then forwards the data traffic to the second destination gateway 828 for the other cloud 845 that hosts the database 855. The route 865 must traverse the floating hub gateway 810 because the gateway router 826 belongs to pool C 834, whereas the gateway router 828 belongs to pool D 836, and thus there is no direct path between the gateway router 826 and the gateway router 828. Once the gateway router 828 receives the data traffic from the floating hub gateway 810, the data traffic is delivered to the database 855 hosted by the cloud 845.

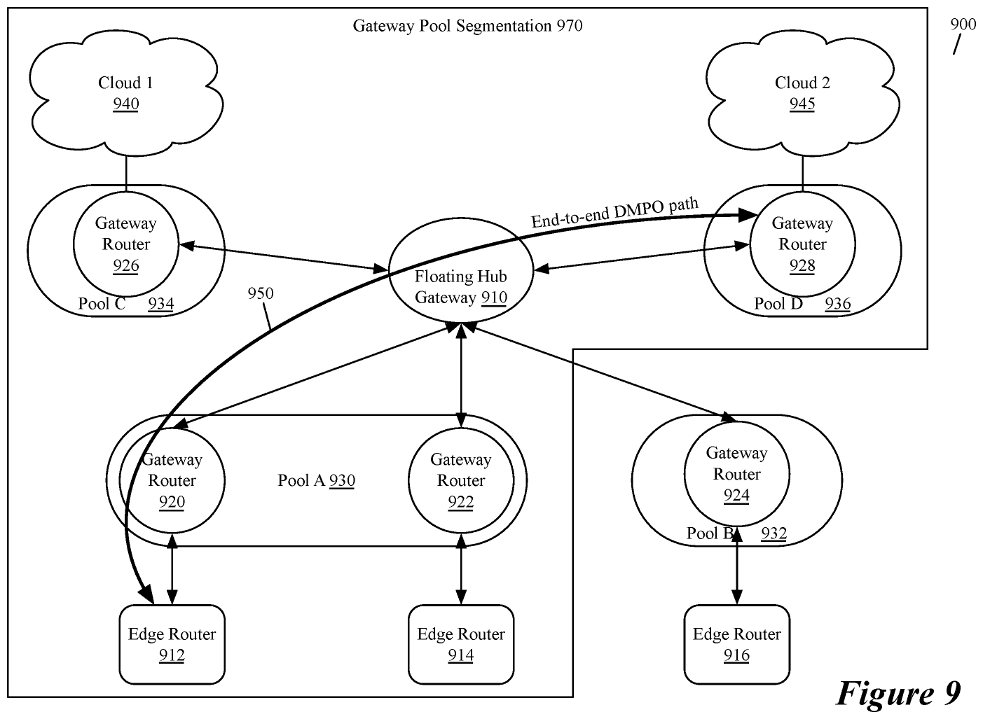

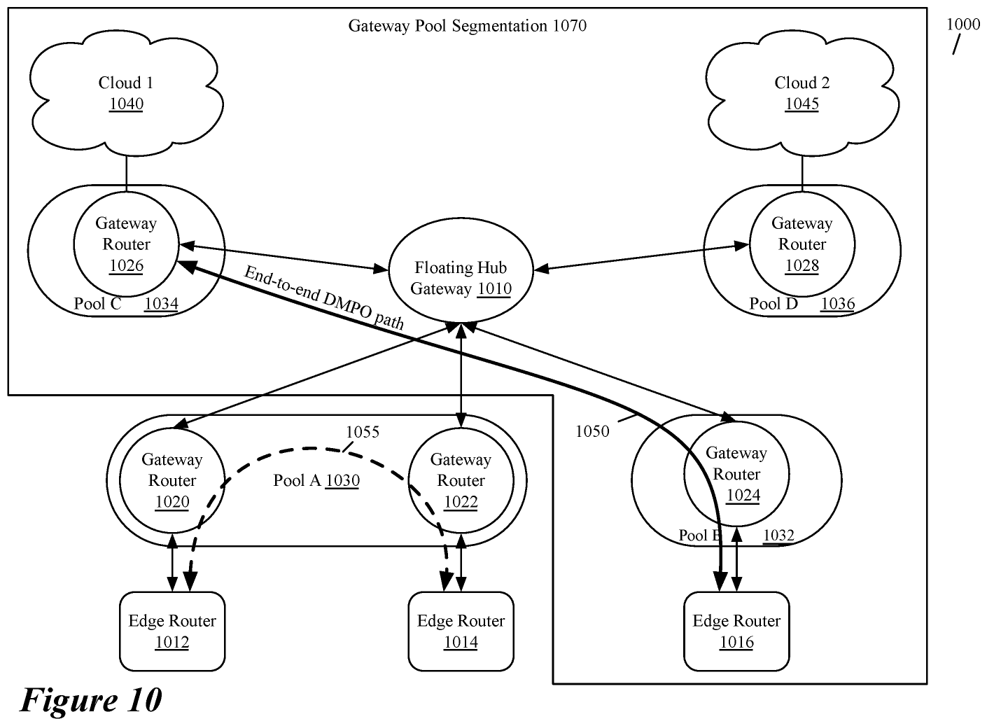

In some embodiments, certain gateway routers and/or groups of gateway routers are segmented to prevent communications between gateway routers in different segments. As mentioned above, the floating hub gateways of some embodiments are enabled with profile-based VPN settings, which can be leveraged to implement the segmentation of gateway routers, in some embodiments. FIGS. 9-10 conceptually illustrate two examples of gateway segmentation for SD-WANs of some embodiments in which floating hub gateways are deployed. In these examples, the floating hub gateway 910 and 1010 is deployed by an SD-WAN controller (not shown) with an isolation profile, and when a route from any gateway routers within a segment is received by the floating hub gateway, the route is only advertised with other gateway routers within the segment based on the profile.

The SD-WAN 900 illustrated by FIG. 9 includes a floating hub gateway 910, edge routers 912-916, clouds 940 and 945, and gateway routers 920-928. The gateway routers 920 and 922 belong to gateway pool A 930, gateway router 924 belongs to gateway pool B 932, gateway router 926 belongs to gateway pool C 934, and gateway router 928 belongs to gateway pool D 936. Additionally, gateway router 920 is the default gateway for edge router 912, gateway router 922 is the default gateway for edge router 914, gateway router 924 is the default gateway for edge router 916, gateway router 926 provides access to cloud 940, and gateway router 928 provides access to cloud 945.

The gateway pool segmentation 970 implemented for the SD-WAN 900 enables communications between gateway routers belonging to pools A 930, C 934, and D 936. Gateway pool B 932 still has a connection to the floating hub gateway 910, but as shown, is isolated and outside of the segment 970. Thus, while edge routers 912 and 914 can communicate with each other via their gateway routers 920 and 922, and reach gateway routers 926 and 928 to access clouds 940 and 945, communications with gateway router 924 (and subsequently edge router 916) are not permitted (i.e., based on the isolation profile). In some embodiments, examples of why the segmentation is implemented can include to keep certain customers (i.e., tenants) from communicating with other customers of the SD-WAN 900, to block certain customers from certain applications hosted by the clouds 940 and 945, etc. For instance, the route 950 connects the edge router 912 to the gateway router 928 through the floating hub gateway 910. However, a similar route cannot exist from the edge router 916 to the gateway router 928 based on the segmentation 970.

FIG. 10 illustrates an SD-WAN 1000 in which a different gateway pool segmentation 1070 is implemented. Like the SD-WAN 900, the SD-WAN 1000 includes a floating hub gateway 1010, edge routers 1012-1016, clouds 1040 and 1045, and gateway routers 1020-1028. The gateway routers 1020 and 1022 belong to gateway pool A 1030, gateway router 1024 belongs to gateway pool B 1032, gateway router 1026 belongs to gateway pool C 1034, and gateway router 1028 belongs to gateway pool D 1036. Additionally, gateway router 1020 is the default gateway for edge router 1012, gateway router 1022 is the default gateway for edge router 1014, gateway router 1024 is the default gateway for edge router 1016, gateway router 1026 provides access to cloud 1040, and gateway router 1028 provides access to cloud 1045.

The gateway pool segmentation 1070 includes pools B 1032, C 1034, and D 1036, indicating communications between the gateways 1024-1028 belonging to these pools 1032-1036 are permitted. Pool A 1030 that includes gateway routers 1020-1022 is isolated from the rest of the gateway routers 1024-1028, while still having a connection to the floating hub gateway 1010. Accordingly, routes between the gateways 1024-1026 are permitted and enabled by the floating hub gateway 1010, such as the route 1050, while gateway routers 1020 and 1022 do not have any routes through the floating hub gateway 1010 to any of the other gateways 1024-1028. However, because gateway routers 1020 and 1022 belong to the same pool A 1030, communications between edge router 1012 and 1014 is possible through the gateway routers 1020 and 1022, such as the route 1055.

In some embodiments, the segmentations 970 and 1070 represent two profiles that exist in the same SD-WAN such that each customer gateway pool (i.e., gateway pools A 930/1030 and B 932/1032) is isolated from each other customer gateway pool, but is still permitted to communicate with gateway pools associated with clouds deployed in the SD-WAN to host various cloud applications. That is, in some embodiments, both the path 950 and the path 1050 exist in the same SD-WAN based on different isolation profiles defined for each customer serviced by the SD-WAN that isolate customers from each other, but not from the clouds deployed in the SD-WAN to host applications or other services.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

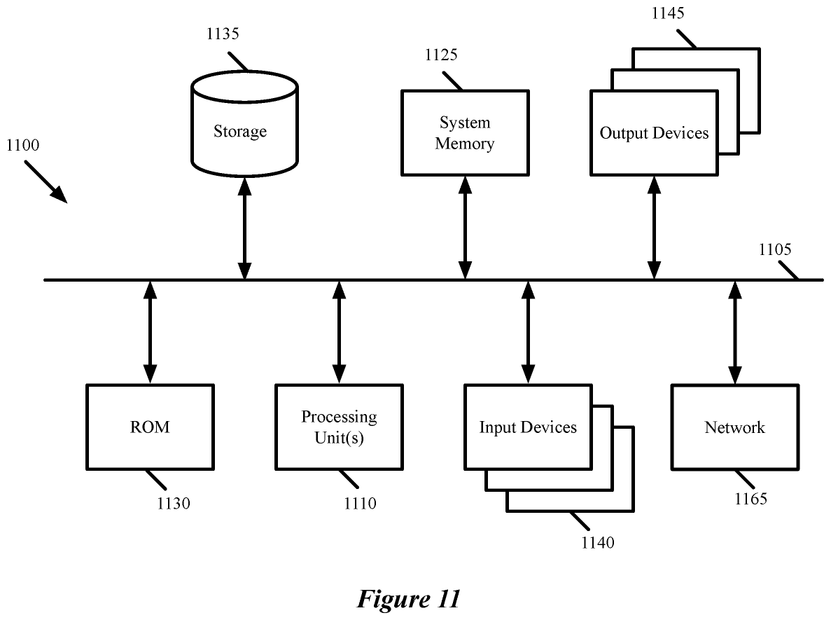

FIG. 11 conceptually illustrates a computer system 1100 with which some embodiments of the invention are implemented. The computer system 1100 can be used to implement any of the above-described hosts, controllers, gateway, and edge forwarding elements. As such, it can be used to execute any of the above described processes. This computer system 1100 includes various types of non-transitory machine-readable media and interfaces for various other types of machine-readable media. Computer system 1100 includes a bus 1105, processing unit(s) 1110, a system memory 1125, a read-only memory 1130, a permanent storage device 1135, input devices 1140, and output devices 1145.

The bus 1105 collectively represents all system, peripheral, and chipset buses that communicatively connect the numerous internal devices of the computer system 1100. For instance, the bus 1105 communicatively connects the processing unit(s) 1110 with the read-only memory 1130, the system memory 1125, and the permanent storage device 1135.

From these various memory units, the processing unit(s) 1110 retrieve instructions to execute and data to process in order to execute the processes of the invention. The processing unit(s) 1110 may be a single processor or a multi-core processor in different embodiments. The read-only-memory (ROM) 1130 stores static data and instructions that are needed by the processing unit(s) 1110 and other modules of the computer system 1100. The permanent storage device 1135, on the other hand, is a read-and-write memory device. This device 1135 is a non-volatile memory unit that stores instructions and data even when the computer system 1100 is off. Some embodiments of the invention use a mass-storage device (such as a magnetic or optical disk and its corresponding disk drive) as the permanent storage device 1135.

Other embodiments use a removable storage device (such as a floppy disk, flash drive, etc.) as the permanent storage device. Like the permanent storage device 1135, the system memory 1125 is a read-and-write memory device. However, unlike storage device 1135, the system memory 1125 is a volatile read-and-write memory, such as random access memory. The system memory 1125 stores some of the instructions and data that the processor needs at runtime. In some embodiments, the invention's processes are stored in the system memory 1125, the permanent storage device 1135, and/or the read-only memory 1130. From these various memory units, the processing unit(s) 1110 retrieve instructions to execute and data to process in order to execute the processes of some embodiments.

The bus 1105 also connects to the input and output devices 1140 and 1145. The input devices 1140 enable the user to communicate information and select commands to the computer system 1100. The input devices 1140 include alphanumeric keyboards and pointing devices (also called “cursor control devices”). The output devices 1145 display images generated by the computer system 1100. The output devices 1145 include printers and display devices, such as cathode ray tubes (CRT) or liquid crystal displays (LCD). Some embodiments include devices such as touchscreens that function as both input and output devices 1140 and 1145.

Finally, as shown in FIG. 11, bus 1105 also couples computer system 1100 to a network 1165 through a network adapter (not shown). In this manner, the computer 1100 can be a part of a network of computers (such as a local area network (“LAN”), a wide area network (“WAN”), or an Intranet), or a network of networks (such as the Internet). Any or all components of computer system 1100 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method for enabling inter-gateway connectivity in an SD-WAN (software-defined wide area network) that connects a plurality of sites, the method comprising:
deploying for the SD-WAN a floating hub gateway router that (i) connects to a plurality of gateway routers each of which is deployed in a cloud and connects to at least one edge router in at least one site, and (ii) does not connect to edge routers at any site;
providing a network address associated with the floating hub gateway router to the plurality of gateway routers deployed in one or more clouds for the SD-WAN; and
configuring the floating hub gateway router to establish a tunnel with each gateway router in the plurality of gateway routers to enable the inter-gateway connectivity between the plurality of gateway routers.

2. The method of claim 1, wherein configuring the floating hub gateway router to establish a tunnel with each gateway router in the plurality of gateway routers comprises configuring the floating hub gateway router to establish, with each gateway router in the plurality of gateway routers, a secure tunnel between the floating hub gateway router and the gateway router using a plurality of physical network links between the floating hub gateway router and the gateway router.

3. The method of claim 2 further comprising configuring the floating hub gateway router to perform a multi-link optimization process to establish each secure tunnel between the floating hub gateway router and each gateway router in the plurality of gateway routers for use in sending data traffic between the floating hub gateway router and each gateway router in the plurality of gateway routers.

4. The method of claim 2, wherein the set of physical network links comprises at least one commercial Internet link.

5. The method of claim 4, wherein the at least one commercial Internet network link is provided by an Internet service provider (ISP).

6. The method of claim 1, wherein the floating hub gateway router enables a full mesh between the plurality of gateway routers.

7. The method of claim 1, wherein the method is performed by an orchestrator that manages the SD-WAN.

8. The method of claim 1, wherein the gateway routers in the plurality of gateway routers are grouped into a set of gateway pools, wherein each gateway router in the plurality of gateway routers belongs to a respective gateway pool in the set of gateway pools.

9. The method of claim 8, wherein:
the SD-WAN is a multi-tenant SD-WAN that serves a plurality of tenants and the plurality of gateway routers is a plurality of multi-tenant gateway routers; and
each gateway pool in the set of gateway pools is associated with at least one tenant in the plurality of tenants served by the multi-tenant SD-WAN.

10. The method of claim 1, wherein:
after providing the network address associated with the floating hub gateway router to the plurality of gateway routers deployed in the SD-WAN, each gateway router in the plurality of gateway routers provides a set of routes associated with the gateway router to the floating hub gateway router; and
the floating hub gateway router provides each set of routes received from each gateway router in the plurality of gateway routers to each other gateway router in the plurality of gateway routers.

11. The method of claim 1 further comprising dynamically adding a new gateway router to the plurality of gateway routers and directing the floating hub gateway router to establish a tunnel with the new gateway router.

12. The method of claim 1 further comprising configuring the floating hub gateway router to act as a route reflector for route distribution.

13. The method of claim 1, wherein deploying the floating hub gateway router in the SD-WAN comprises deploying the floating hub gateway router in the SD-WAN with an isolation profile identifying a first subset of gateway routers that are not permitted to communicate with a second subset of gateway routers.

14. The method of claim 13, wherein:
the SD-WAN is a multi-tenant SD-WAN that serves a plurality of tenants and the plurality of gateway routers is a plurality of multi-tenant gateway routers;
the first subset of gateway routers is associated with a first tenant in the plurality of tenants of the multi-tenant SD-WAN and the second subset of gateway routers is associated with a second tenant in the plurality of tenants of the multi-tenant SD-WAN; and
the isolation profile prevents communications between the first and second tenants.

15. The method of claim 14, wherein:
a third subset of gateway routers is associated with a set of clouds that are connected by the SD-WAN and that each host one or more applications for providing one or more services to tenants of the SD-WAN; and
the isolation profile enables the first and second subsets of gateway routers to communicate with the third subset of gateway routers in order to access the one or more services provided by the one or more applications hosted by the set of clouds.

16. A non-transitory machine readable medium storing a program for execution by a set of processing units, the program for enabling inter-gateway connectivity in an SD-WAN (software defined wide area network) that that connects a plurality of sites, the program comprising sets of instructions for:
deploying for the SD-WAN a floating hub gateway router that (i) connects to a plurality of gateway routers each of which is deployed in a cloud and connects to at least one edge router in at least one site, and (ii) does not connect to edge routers at any site;
providing a network address associated with the floating hub gateway router to the plurality of gateway routers deployed in one or more clouds for the SD-WAN; and
configuring the floating hub gateway router to establish a tunnel with each gateway router in the plurality of gateway routers to enable the inter-gateway connectivity between the plurality of gateway routers.

17. The non-transitory machine readable medium of claim 16, wherein the set of instructions for configuring the floating hub gateway router to establish a tunnel with each gateway router in the plurality of gateway routers comprises a set of instructions for configuring the floating hub gateway router to establish, with each gateway router in the plurality of gateway routers, a secure tunnel between the floating hub gateway router and the gateway router using a plurality of physical network links between the floating hub gateway router and the gateway router, wherein the set of physical network links comprises at least one commercial Internet link provided by an Internet service provider (ISP).

18. The non-transitory machine readable medium of claim 17 further comprising a set of instructions for configuring the floating hub gateway router to perform a multi-link optimization process to establish each secure tunnel between the floating hub gateway router and each gateway router in the plurality of gateway routers for use in sending data traffic between the floating hub gateway router and each gateway router in the plurality of gateway routers.

19. The non-transitory machine readable medium of claim 16, wherein:
the SD-WAN is a multi-tenant SD-WAN that serves a plurality of tenants and the plurality of gateway routers is a plurality of multi-tenant gateway routers,
the gateway routers in the plurality of gateway routers are grouped into a set of gateway pools,
each gateway router in the plurality of gateway routers belongs to a respective gateway pool in the set of gateway pools, and
each gateway pool in the set of gateway pools is associated with at least one tenant in the plurality of tenants serviced by the multi-tenant SD-WAN.

20. The non-transitory machine readable medium of claim 16, wherein:
after providing the network address associated with the floating hub gateway router to the plurality of gateway routers deployed in the SD-WAN, each gateway router in the plurality of gateway routers provides a set of routes associated with the gateway router to the floating hub gateway router; and
the floating hub gateway router provides each set of routes received from each gateway router in the plurality of gateway routers to each other gateway router in the plurality of gateway routers.
